(19) United States
(12) Patent Application Publication
(10) Pub. No.: US 2013/0077309 A1
(43) Pub. Date: Mar. 28, 2013

(54) AREA LIGHT SOURCE MODULE WITH MULTIPOINT CHIP-ON-BOARD

(71) Applicant: Chih-Yung HOU, Taichung City (TW)

(72) Inventor: Chih-Yung HOU, Taichung City (TW)

(21) Appl. No.: 13/419,191

(22) Filed: Mar. 13, 2012

(30) Foreign Application Priority Data
Sep. 27, 2011 (TW) 100218023

(51) Int. Cl. F21V 21/00

(52) U.S. Cl. 362/249.01; 362/382

(57) ABSTRACT

The present invention relates to an area light source module with multipoint chip-on-board. With separatively-disposed multipoint chip conductive layer portions and conductive wiring layer portions disposed between multipoint chip conductive layer portions of a substrate body, it can be more flexible for the wire-bonding and conductive connection and the circuit design of conductive metal wire bodies to be formed in serial and parallel connections, and also the whole assembly structure and the manufacturing process can be simplified, thereby facilitating the heat dissipation efficiency of light source chip bodies to increase the illumination efficiency and providing stable structural configuration and illumination.

The current application claims a foreign priority to a patent application in Taiwan with a serial number 100218023 filed on Sep. 27, 2011.

### BACKGROUND OF THE INVENTION

1. Field of the Invention

The present invention relates to an area light source module with multipoint chip-on-board (COB), in particular relates to an area light source module with COB applied in the related technical field.

2. Description of the Related Art

Referring to FIG. 9, a conventional surface mounted device (SMD) light-emitting diode (LED) light source structure is illustrated. The SMD LED light source assembly 50 includes a chip 51, an adhesive 52, frames 53 and a substrate body 54, wherein the chip 51 is attached on the frames 53 by the adhesive 52. The adhesive 52 is generally made by a mixture of epoxy resin and metal powder, wherein the epoxy resin characterized with being hardened by high temperature is utilized to secure the chip 51, and the metal powder is functioned to achieve electric and heat conductions. The frames 53 are conductively connected to positive and negative portions (not shown in Figs.) of the substrate body 54.

However, due to a large clearance formed between the chip and the frame caused by material properties and the adhesive having inferior adhesion force caused by large voids among molecules, the structure of the SMD LED light source assembly is unstable and cannot stand large thrust and tensile forces. Furthermore, due to the chip attached on the frames by the adhesive to be covered by the adhesive, the heat dissipation efficiency and the illumination efficiency of the chip are reduced, thus to cause an unstable illumination.

### BRIEF SUMMARY OF THE INVENTION

In view of this, the present invent provides an area light source module with multipoint chip-on-board (COB) to solve the unstable structure and illumination in the SMD LED light source assembly.

The main purpose of the present invention is to provide an area light source module with multipoint COB. The area light source module with multipoint COB comprises a substrate body, a plurality of light source chip bodies, a plurality of conductive metal wire bodies and a plurality of encapsulating layer bodies. The substrate body comprises a plurality of multipoint chip conductive layer portions and a plurality of conductive wiring layer portions disposed between the multipoint chip conductive layer portions, and each of the conductive wiring layer portions comprises a positive conductive portion and a negative conductive portion. The light source chip bodies are disposed on the multipoint chip conductive layer portions of the substrate body. The conductive metal wire bodies are respectively conductively connected between each of the light source chip bodies and the conductive wiring layer portions of the substrate body, and each of the conductive metal wire bodies has a wire-bonding and conductive connection in which the light source chip body is respectively wire-bonded and conductively connected to the positive conductive portion and the negative conductive portion of the conductive wiring layer portion of the substrate body. The encapsulating layer body, disposed on the multipoint chip conductive layer portions of the substrate body and between the multipoint chip conductive layer portions and the conductive wiring layer portions of the substrate body, is outwardly extended from the multipoint chip conductive layer portion of the substrate body to the end of the conductive wiring layer portion where is located on the wire-bonding and conductively connected position of the conductive metal wire body. With the separatively-disposed multipoint chip conductive layer portions and the conductive wiring layer portions disposed between the multipoint chip conductive layer portions of the substrate body, it can be more flexible for the wire-bonding and conductive connection and the circuit design of the conductive metal wire bodies to be formed in serial and parallel connections, and also the whole assembly structure and the manufacturing process can be simplified, thereby facilitating the heat dissipation efficiency of the light source chip bodies to increase the illumination efficiency and providing stable structural configuration and illumination.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view showing a structure of a substrate having multipoint metal conductive layer portions of the present invention;

FIG. 2 is a top view schematically showing a substrate having multipoint metal conductive layer portions of the present invention;

FIG. 3 is a schematic view showing a combination state of a substrate having multipoint metal conductive layer portions, light source chips, lead wires and encapsulating layers of the present invention;

FIG. 4 is a side sectional view schematically showing a combination state of a substrate having multipoint metal conductive layer portions, light source chips, lead wires and encapsulating layers of the present invention;

FIG. 5 is a schematic view showing a structure of a substrate having multipoint metal conductive layer portions of a first embodiment of the present invention;

FIG. 6 is a schematic view showing a combination state of a substrate having multipoint metal conductive layer portions, light source chips, lead wires and encapsulating layers of a first embodiment of the present invention;

FIG. 7 is a schematic view showing a structure of a substrate having multipoint metal conductive layer portions of a second embodiment of the present invention;

FIG. 8 is a schematic view showing a combination state of a substrate having multipoint metal conductive layer portions, light source chips, lead wires and encapsulating layers of a second embodiment of the present invention; and

FIG. 9 is a reference view showing a structure of a conventional surface mounted device (SMD) light-emitting diode (LED) light source.

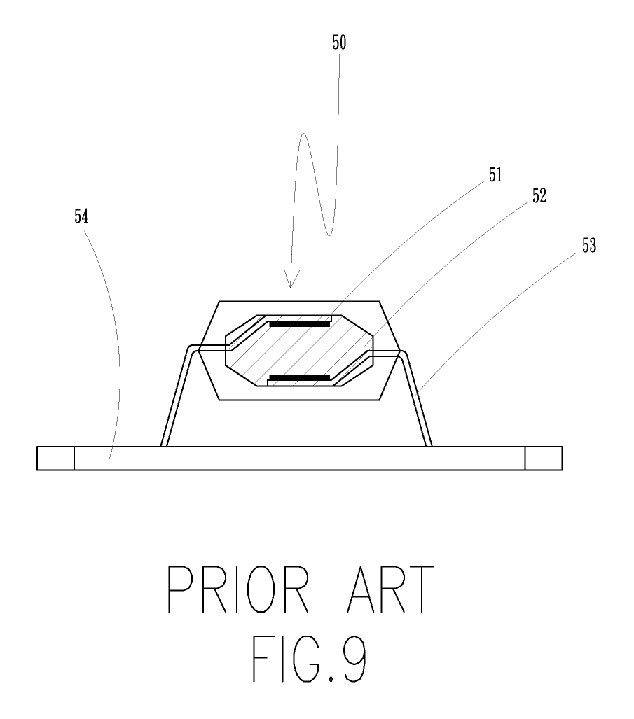

### DETAILED DESCRIPTION OF THE INVENTION

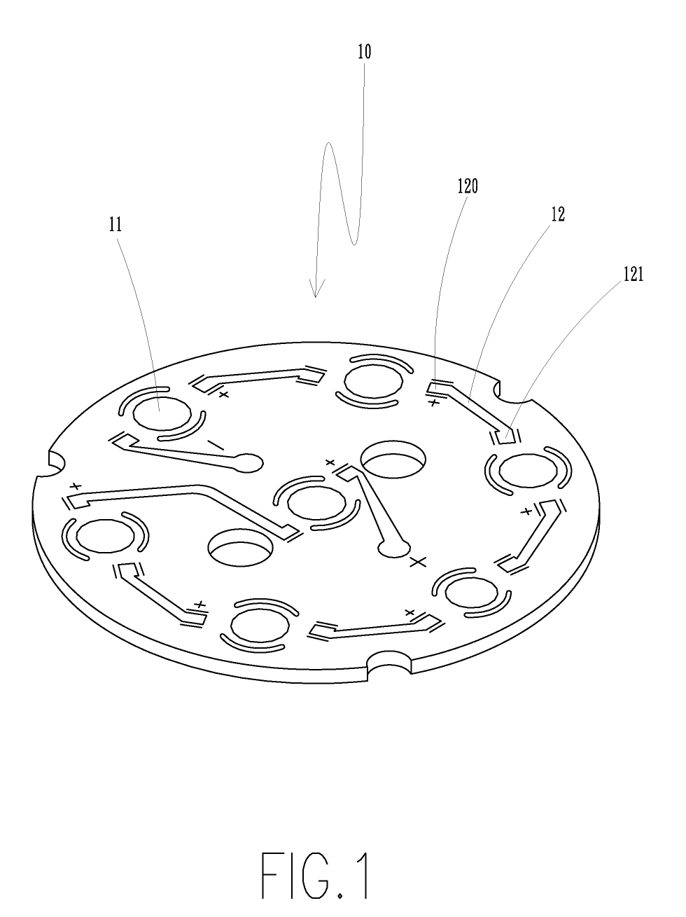

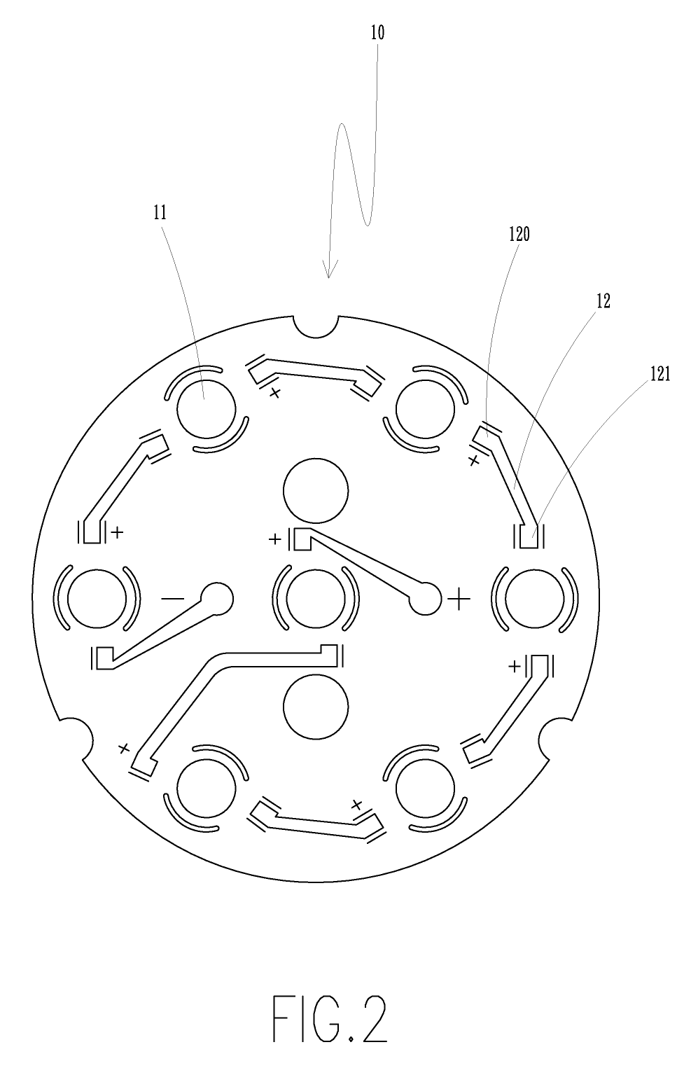

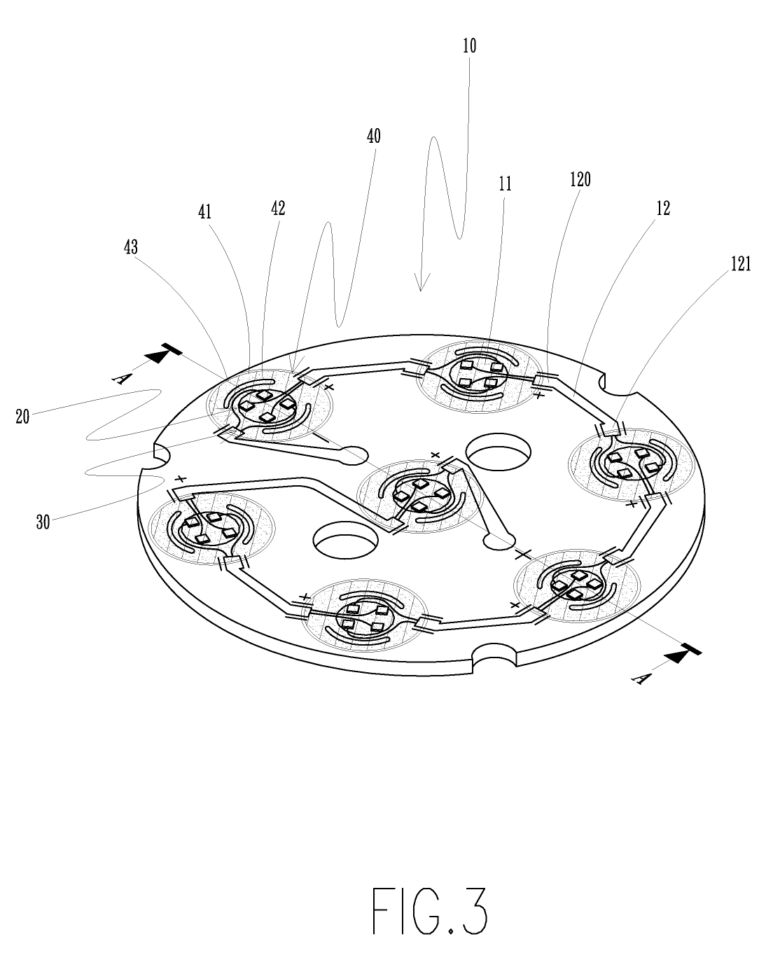

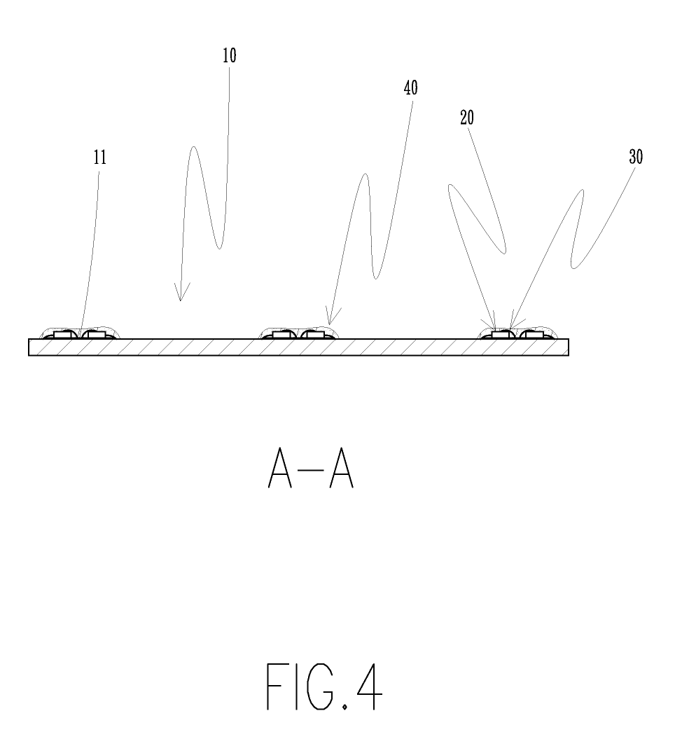

Referring to FIGS. 1, 2, 3 and 4, FIG. 1 is a schematic view showing a structure of a substrate having multipoint metal conductive layer portions of an area light source module with multipoint chip-on-board (COB) of the present invention, FIG. 2 is a top view of the substrate having the multipoint metal conductive layer portions, FIG. 3 is a schematic view showing a combination state of the substrate having the multipoint metal conductive layer portions, light source chips, lead wires and encapsulating layers, and FIG. 4 is a side sectional view schematically showing the combination state of the substrate having the multipoint metal conductive layer portions, the light source chips, the lead wires and the encapsulating layers.

The area light source module with multipoint COB comprises a substrate body 10, a plurality of light source chip bodies 20, a plurality of conductive metal wire bodies 30 and a plurality of encapsulating layer bodies 40.

The substrate body 10 comprises a plurality of multipoint chip conductive layer portions 11 and a plurality of conductive wiring layer portions 12 disposed between the multipoint chip conductive layer portions 11, and each of the conductive wiring layer portions 12 comprises a positive conductive portion 120 and a negative conductive portion 121. In this embodiment, the multipoint chip conductive layer portion 11 of the substrate body 10 is formed in circle shape.

The light source chip bodies 20 are disposed on the multipoint chip conductive layer portions 11 of the substrate body 10.

The conductive metal wire bodies 30, respectively conductively connected between each of the light source chip bodies 20 and the conductive wiring layer portions 12 of the substrate body 10, has a wire-bonding and conductive connection in which each of the light source chip bodies 20 is respectively wire-bonded and conductively connected to the positive conductive portion 120 and the negative conductive portion 121 of the conductive wiring layer portion 12 of the substrate body 10.

The encapsulating layer body 40, disposed on the multipoint chip conductive layer portions 11 of the substrate body 10, is outwardly extended from the multipoint chip conductive layer portion 11 of the substrate body 10 to an end of the conductive wiring layer portion 12 where is located on a wire-bonding and conductively-connected position of the conductive metal wire body 30. The encapsulating layer body 40 comprises a transparent circular frame encapsulation 41, a fluorescent powder 42 and a transparent encapsulating glue 43, wherein the transparent circular frame encapsulation 41 capable of being formed by any shapes is circumferentially disposed on the outer side of the fluorescent powder 42 and the transparent encapsulating glue 43.

The area light source module with multipoint COB of the present invention is completed by the combination of the above-described structures.

Referring to FIGS. 3 and 4, FIG. 3 is a schematic view showing a combination state of a substrate having multipoint metal conductive layer portions, light source chips, lead wires and encapsulating layers of the present invention, and FIG. 4 is a side sectional view showing the combination state of the substrate having the multipoint metal conductive layer portions, the light source chips, the lead wires and the encapsulating layers according to line A-A in FIG. 3. The light source chip bodies 20 are disposed on the multipoint chip conductive layer portions 11 of the substrate body 10. The conductive metal wire bodies 30 are respectively conductively connected between each of the light source chip bodies 20 and the conductive wiring layer portions 12 of the substrate body 10, and each of the conductive metal wire bodies 30 has a wire-bonding and conductive connection in which the light source chip body 20 is respectively wire-bonded and conductively connected to the positive conductive portion 120 and the negative conductive portion 121 of the conductive wiring layer portion 12 of the substrate body 10. The encapsulating layer body 40, disposed on the multipoint chip conductive layer portions 11 of the substrate body 10 and between the multipoint chip conductive layer portions 11 and the conductive wiring layer portions 12 of the substrate body 10, is outwardly extended from the multipoint chip conductive layer portion 11 of the substrate body 10 to the end of the conductive wiring layer portion 12 where is located on the wire-bonding and conductively connected position of the conductive metal wire body 30. With the separatively-disposed multipoint chip conductive layer portions 11 and the conductive wiring layer portions 12 disposed between the multipoint chip conductive layer portions 11 of the substrate body 10, it can be more flexible for the wire-bonding and conductive connection and the circuit design of the conductive metal wire bodies 30 to be formed in serial and parallel connections, and also the whole assembly structure and the manufacturing process can be simplified, thereby facilitating the heat dissipation efficiency of the light source chip bodies 20 to increase the illumination efficiency and providing stable structural configuration and illumination.

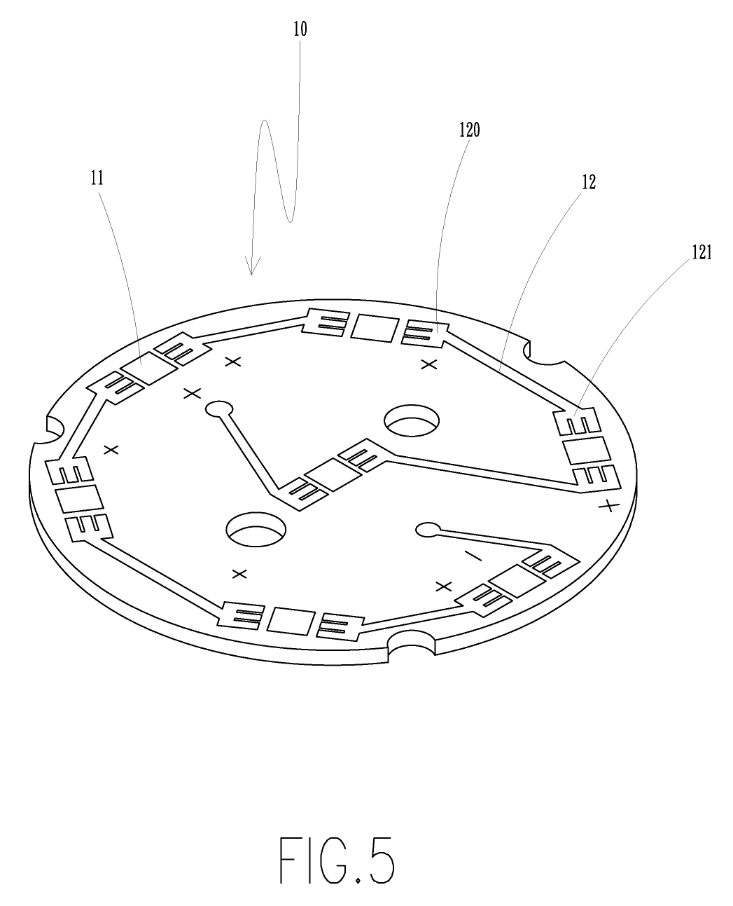

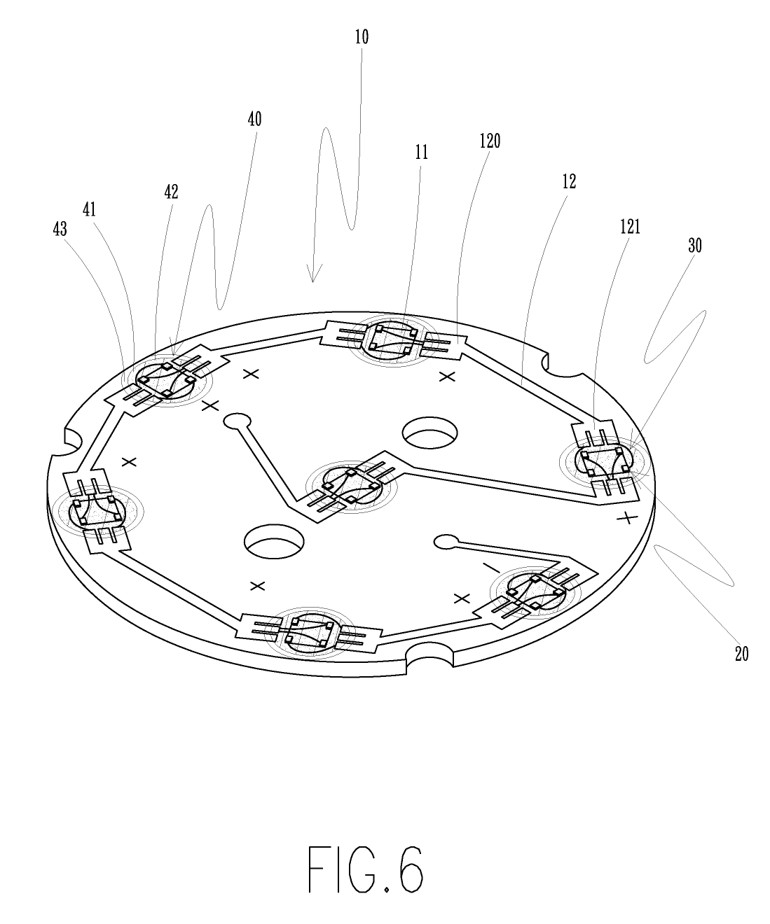

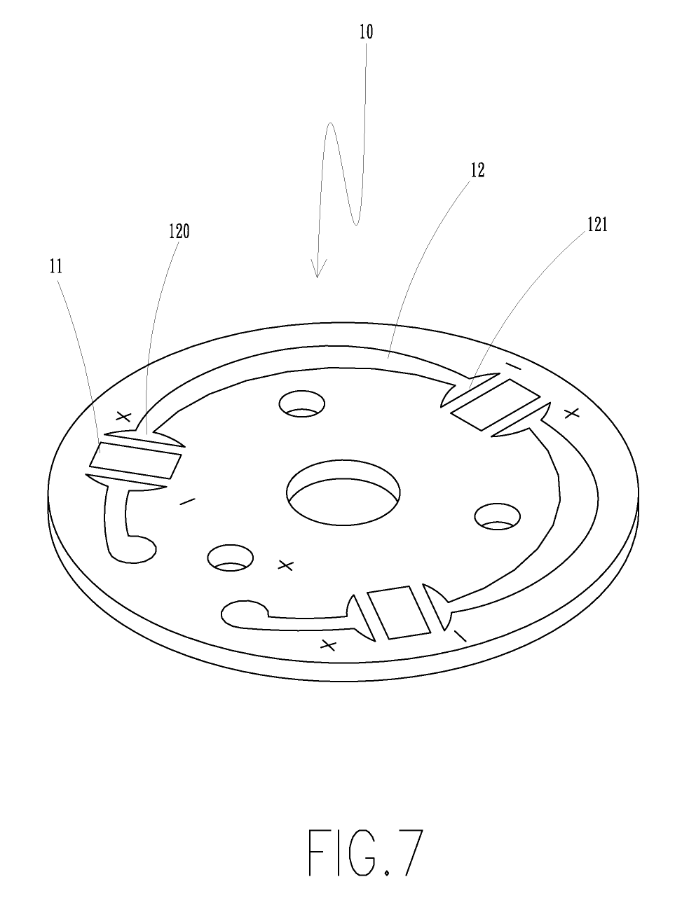

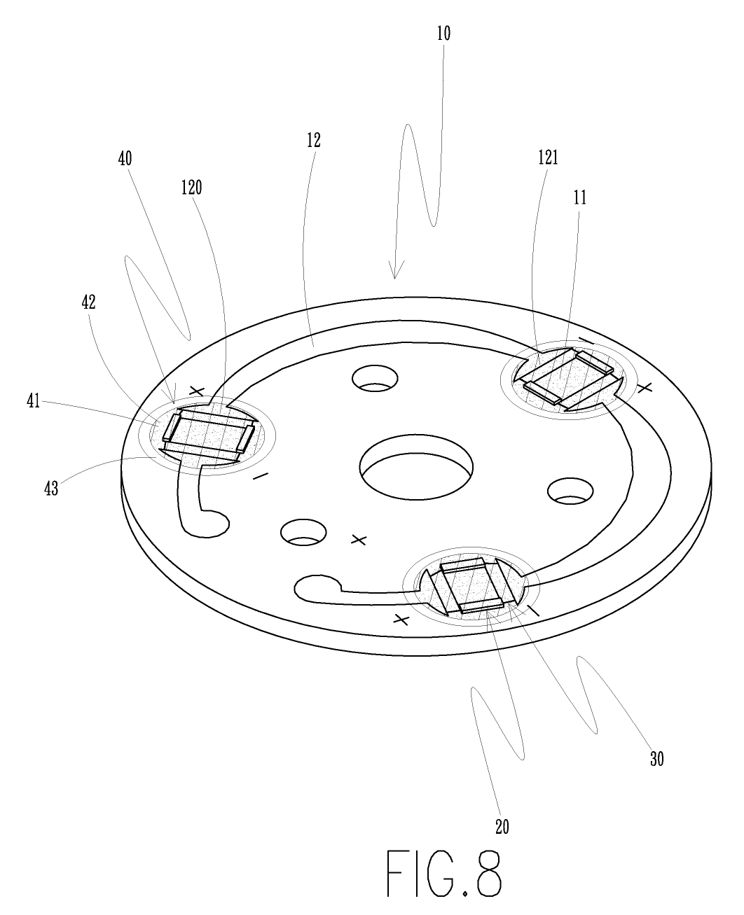

Referring to FIGS. 5, 6, 7 and 8, FIG. 5 is a schematic view showing a structure of a substrate having multipoint metal conductive layer portions of a first embodiment of the area light source module with multipoint COB of the present invention, FIG. 6 is a schematic view showing a combination state of a substrate having multipoint metal conductive layer portions, light source chips, lead wires and encapsulating layers of the first embodiment, FIG. 7 is a schematic view showing a structure of a substrate having multipoint metal conductive layer portions of a second embodiment of the area light source module with multipoint COB of the present invention, and FIG. 8 is a schematic view showing a combination state of a substrate having multipoint metal conductive layer portions, light source chips, lead wires and encapsulating layers of the second embodiment. The whole structure of the first embodiment of FIGS. 5 and 6 differs from that of FIGS. 1, 2 and 3 in that the multipoint chip conductive layer portions 11 of the substrate body 10 is formed in square shape, and the positive conductive portion 120 and the negative conductive portion 121 of the conductive wiring layer portion 12 of the substrate body 10 is formed in forked shape. The whole structure of the first embodiment of FIGS. 7 and 8 differs from that of FIGS. 1, 2 and 3 in that the multipoint chip conductive layer portions 11 of the substrate body 10 is formed in rectangular shape, and the positive conductive portion 120 and the negative conductive portion 121 of the conductive wiring layer portion 12 of the substrate body 10 is formed in arc shape. In FIG. 6, the light source chip bodies 20 are disposed on the rectangular multipoint chip conductive layer portions 11 of the substrate body 10, the conductive metal wire bodies 30 are respectively conductively connected between each of the light source chip bodies 20 and the conductive wiring layer portions 12 of the substrate body 10, and each of the conductive metal wire bodies 30 has a wire-bonding and conductive connection in which the light source chip body 20 respectively wire-bonded and conductively connected to the forked positive conductive portion 120 and the forked negative conductive portion 121 of the conductive wiring layer portion 12 of the substrate body 10. In FIG. 8, the light source chip bodies 20 are disposed on the square multipoint chip conductive layer portions 11 of the substrate body 10, the conductive metal wire bodies 30 are respectively conductively connected between each of the light source chip bodies 20 and the conductive wiring layer portions 12 of the substrate body 10, and each of the conductive metal wire bodies 30 has a wire-bonding and conductive connection in which the light source chip body 20 respectively wire-bonded and conductively connected to the arc positive conductive portion 120 and the arc negative conductive portion 121 of the conductive wiring layer portion 12 of the substrate body 10. With the configuration of the square or rectangular multipoint chip conductive layer portions 11 and the forked or arc positive conductive portion 120 and the forked or arc negative conductive portion 121 of the conductive wiring layer portion 12, it can be appreciated that the utility of the present invention is increased.

With the separatively-disposed multipoint chip conductive layer portions and the conductive wiring layer portions disposed between the multipoint chip conductive layer portions of the substrate body, it can be more flexible for the wire-bonding and conductive connection and the circuit design of the conductive metal wire bodies to be formed in serial and parallel connections, and also the whole assembly structure and the manufacturing process can be simplified, thereby facilitating the heat dissipation efficiency of the light source chip bodies to increase the illumination efficiency and providing stable structural configuration and illumination.

In conclusion, the present invention surely can attain the above-described functions and purposes and comply with the requirements of patent application. While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An area light source module with multipoint chip-on-board, comprising:
a substrate body comprising a plurality of multipoint chip conductive layer portions and a plurality of conductive wiring layer portions disposed between the multipoint chip conductive layer portions, each of the conductive wiring layer portions comprising a positive conductive portion and a negative conductive portion.

2. The area light source module with multipoint chip-on-board as claimed in claim 1, wherein the multipoint chip conductive layer portions of the substrate body is formed in circle, square or rectangular shape.

3. The area light source module with multipoint chip-on-board as claimed in claim 1, wherein the positive conductive portion and the negative conductive portion of the conductive wiring layer portion of the substrate body is formed in forked or arc shape.

4. An area light source module with multipoint chip-on-board, comprising:
a substrate body comprising a plurality of multipoint chip conductive layer portions and a plurality of conductive wiring layer portions disposed between the multipoint chip conductive layer portions, each of the conductive wiring layer portions comprising a positive conductive portion and a negative conductive portion;
a plurality of light source chip bodies disposed on the multipoint chip conductive layer portions of the substrate body;
a plurality of conductive metal wire bodies respectively conductively connected between each of the light source chip bodies and the conductive wiring layer portions of the substrate body, comprising a wire-bonding and conductive connection in which each of the light source chip bodies is respectively wire-bonded and conductively connected to the positive conductive portion and the negative conductive portion of the conductive wiring layer portion of the substrate body; and
a plurality of encapsulating layer bodies disposed on the multipoint chip conductive layer portions of the substrate body and between the multipoint chip conductive layer portions and the conductive wiring layer portions of the substrate body, comprising an outer side and a transparent circular frame encapsulation circumferentially disposed on the outer side and formed by any shapes.

5. The area light source module with multipoint chip-on-board as claimed in claim 4, wherein the multipoint chip conductive layer portions of the substrate body is formed in circle, square or rectangular shape.

6. The area light source module with multipoint chip-on-board as claimed in claim 4, wherein the positive conductive portion and the negative conductive portion of the conductive wiring layer portion of the substrate body is formed in forked or arc shape.

7. The area light source module with multipoint chip-on-board as claimed in claim 4, wherein the encapsulating layer body further comprises a transparent encapsulating glue and a fluorescent powder.

8. The area light source module with multipoint chip-on-board as claimed in claim 4, wherein the encapsulating layer body is outwardly extended from the multipoint chip conductive layer portion of the substrate body to an end of the conductive wiring layer portion where is located on a wire-bonding and conductively-connected position of the conductive metal wire body.
